(19) United States
(12) Patent Application Publication
(10) Pub. No.: US 2017/0166073 A1
(43) Pub. Date: Jun. 15, 2017

(54) VEHICLE AND CHARGING CONTROL METHOD OF VEHICLE

(71) Applicant: HYUNDAI MOTOR COMPANY, Seoul (KR)

(72) Inventor: Hyun Soo PARK, Anyang-si (KR)

(21) Appl. No.: 15/225,218

(22) Filed: Aug. 1, 2016

(30) Foreign Application Priority Data
Dec. 9, 2015 (KR) 10-2015-0174668

(51) Int. Cl. B60L 11/18; B60L 3/00; H02J 7/00

(52) U.S. Cl. CPC B60L 11/1838; H02J 7/0026; B60L 11/1816; B60L 11/1861; B60L 11/1859; B60L 3/0046

(57) ABSTRACT

A charging control method of a vehicle including an electric motor for supplying power for driving wheels and a battery for driving the electric motor includes a battery management system (BMS) for determining whether the battery is normal or not, activating a power blocking unit provided on a power output path of the battery upon determining that the battery is in an over discharge state, deactivating the power blocking unit upon sensing that a charging connector of an external charger is connected, and starting charging of the battery with charging power supplied through the charging connector while the power blocking unit is deactivated.

### CROSS-REFERENCE TO RELATED APPLICATION

This application claims the benefit of priority to Korean Patent Application No. 10-2015-0174668, filed on Dec. 9, 2015 with the Korean Intellectual Property Office, which is hereby incorporated by reference as if fully set forth herein.

### TECHNICAL FIELD

The present disclosure relates to a vehicle capable of efficiently performing charging when a battery for driving an electric motor is discharged, and a charging control method of the vehicle.

### BACKGROUND

A hybrid electric vehicle (HEV) attracts considerable attention as an eco-friendly vehicle.

A hybrid vehicle generally refers to a vehicle using two power sources. The two power sources may include an engine and an electric motor. Such a hybrid vehicle has excellent mileage and power performance as compared to a vehicle having only an internal combustion engine, and further emits decreased emissions. Therefore, many hybrid vehicles have been developed.

Among hybrid vehicles, a plug-in hybrid electric vehicle (PHEV) may be plugged into a power source to charge a battery for driving an electric motor with external power.

In addition, an electric vehicle (EV) also attracts considerable attention as eco-friendly vehicle. Since the electric vehicle is generally driven using only an electric motor, a battery for driving the electric motor needs to be charged.

When a battery mounted in such an EV or PHEV in order to drive a motor is discharged to a predetermined level or more (that is, over discharged), the vehicle may separate the battery and an in-vehicle load or a power delivery path of a charger in order to prevent continuous over discharge of the battery. Accordingly, additional discharge of the battery can be prevented but the battery cannot be charged unless the battery is separated from the vehicle.

### SUMMARY

The present disclosure is directed to a vehicle and a charging control method thereof that substantially obviate one or more problems due to limitations and disadvantages of the related art.

An object of the present disclosure is to provide a vehicle for more efficiently providing a charging function upon over discharge of a battery, and a control method thereof.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a charging control method of a vehicle including an electric motor and a battery for driving the electric motor may include a battery management system (BMS) for determining whether the battery is normal or not, activating a power blocking unit provided on a power output path of the battery upon determining that the battery is in an over discharge state, deactivating the power blocking unit upon sensing that a charging connector of an external charger is connected, and starting charging of the battery with charging power supplied through the charging connector while the power blocking unit is deactivated.

According to another aspect of the present disclosure, there is provided a vehicle including an electric motor for supplying power for driving wheels, a battery for supplying power to the electric motor, a power blocking unit provided on a power output path of the battery, and a battery management system (BMS) for sensing a state of the battery and controlling the power blocking unit, wherein the battery management system activates the power blocking unit provided on the power output path of the battery when it is determined that the battery is in an over discharge state, deactivates the power blocking unit upon sensing that a charging connector of an external charger is connected, and starting charging of the battery with charging power supplied through the charging connector while the power blocking unit is deactivated.

At least one embodiment of the present disclosure includes the following effect.

Even when the battery is over discharged, it is possible to perform charging without separating the battery.

The aspects of the present disclosure are only a part of the embodiments of the present disclosure, and various embodiments based on technical features of the present disclosure may be devised and understood by one of ordinary skill in the art based on the detailed description of the present disclosure.

### BRIEF DESCRIPTION OF THE DRAWINGS

The accompanying drawings, which are included to provide a further understanding of the disclosure and are incorporated in and constitute a part of this application, illustrate embodiments of the disclosure and, together with the description, serve to explain the principles of the disclosure. In the drawings:

FIG. 1 is a diagram showing an example of a charging system structure of a general vehicle; and

FIG. 2 is a flowchart illustrating an example of a charging control process upon over discharge of a battery in a vehicle according to an embodiment of the present disclosure.

### DETAILED DESCRIPTION

Reference will now be made in detail to embodiments of the present disclosure, examples of which are illustrated in the accompanying drawings. Wherever possible, the same reference numbers will be used throughout the drawings to refer to the same or like parts, and a repeated description thereof will be omitted. The suffixes “module” and “unit” of elements herein are used for convenience of description and thus can be used interchangeably and do not have any distinguishable meanings or functions.

In describing the embodiments of the present disclosure, if it is determined that the detailed description of a related known function or construction renders the scope of the present disclosure unnecessarily ambiguous, the detailed description thereof will be omitted. In addition, the accompanying drawings are provided only for a better understanding of the embodiments disclosed in the present specification, and are not intended to limit technical concepts disclosed in the present specification. Therefore, it should be understood that the accompanying drawings include all modifications, equivalents and substitutions within the scope and sprit of the present disclosure.

In addition, in the present specification, the term “battery” may refer to a battery for supplying power to an electric motor, not to a 12-V battery used to operate an electrical apparatus of a general vehicle, unless otherwise stated. In addition, the vehicle described in the present specification includes an electric vehicle (EV), a plug-in electric car (PEV), a plug-in hybrid electric vehicle (PHEV) and a fuel cell electric vehicle (FCEV).

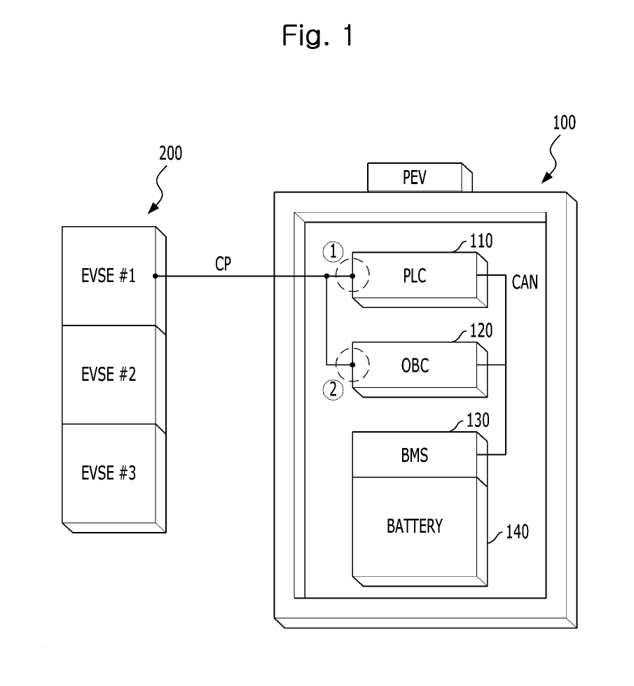

Prior to description of a vehicle charging system according to embodiments of the present disclosure, a general vehicle charging system will be described with reference to FIG. 1.

FIG. 1 is a diagram showing an example of a general charging system.

Although a charging system of an electric vehicle (EV) or a plug-in electric vehicle (PEV) is shown in FIG. 1, the charging system of FIG. 1 is similarly applicable to a PHEV except for parts related to an engine driven using a fossil fuel.

Referring to FIG. 1, the charging system 100 of the EV may include a quick charger controller 110, that is, a power line communication (PLC)/electric vehicle communication controller (EVCC), an on-board charger (OBC) controller 120 for controlling slow charging, a battery management system 130 and a battery 140.

The EVCC, the OBC controller and the BMS may be connected to each other through controller area network (CAN) communication. In addition, the charging system 100 may be connected to a charger (electric vehicle supply equipment (EVSE)) 200 via a charging connector. The charger 200 may transmit a pulse width modulation (PWM) signal to a vehicle via a control pilot (C/P) line and the vehicle may determine whether slow charging or quick charging is performed through a duty ratio of the PWM signal (that is, a ratio of the H signal and L signal of the pulse width).

The BMS 130 may monitor state information of the battery 140 and receive and deliver charging power from the quick charger controller 110 or the OBC controller 120 to the battery 140. In addition, the BMS 130 may determine whether output (charging power and discharge power) of the battery 140 is allowed and block an output path according to the determination. A relay (not shown) may be used to block the output path. In this case, the BMS 130 may control the output path for supplying charging power to the battery or supplying discharge power to a variety of loads which use battery power, by turning the relay on/off. As a result, the BMS 130 may turn the relay off as a fault reaction method when it is determined that the battery 140 is in an over discharge state, thereby blocking charging/discharge power.

Such relay control may block a path for supplying charging power even when the cable of the external charger 200 is connected to the vehicle, such that charging may be impossible unless the battery 140 is separated from the vehicle.

Accordingly, in one embodiment of the present disclosure, when the charging connector of the external charger is connected in a state in which the battery is in an over discharge (that is, a low-voltage) state, fault reaction to over discharge is released and charging may be performed. In addition, when it is difficult to perform charging in a state in which fault reaction to over discharge is released, fault reaction may be immediately performed.

According to one aspect of the present disclosure, fault reaction to over discharge of the battery may block the output path of the battery using the relay.

In addition, according to one aspect of the present disclosure, when charging starts according to a normal charging sequence but 1) charging current is equal to or less than a predetermined value, 2) charging power is greater than discharge power even upon performing charging or 3) a low voltage state is maintained (the voltage of the battery does not increase), it may be difficult to perform charging in a state in which fault reaction to over discharge is released.

A determination as to whether the battery is in an over discharge state and control of the relay for blocking the output path of the battery power may be performed in the BMS.

According to one aspect of an embodiment, although the battery is normal upon charging, when the battery transitions to a low voltage state upon charging, charging may be finished and fault reaction to over discharge may be performed.

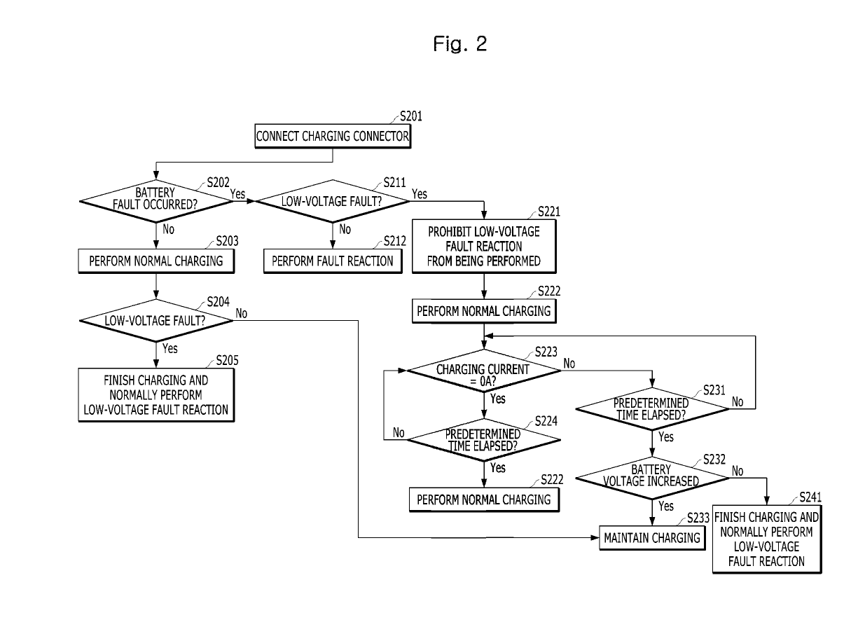

A flowchart of the above-described control procedure is shown in FIG. 2.

FIG. 2 is a flowchart illustrating an example of a charging control process upon over discharge of a battery in a vehicle according to one embodiment of the present disclosure.

In FIG. 2, for convenience, the over discharge state of the battery is referred to as “low-voltage fault” and fault reaction to over discharge is referred to as “low-voltage fault reaction”.

Referring to FIG. 2, first, the charging connector of an external charger may be connected to the vehicle (S201). Whether the connector is connected may be sensed according to the method described in the charging standard. For example, in case of a combo method (DC combo, TYPE 1), a slow/quick charger controller may receive and transmit a control pilot (CP) signal of a pulse width modulation (PWM) method to the BMS.

The BMS may sense whether the battery is normal (S202) before performing the charging sequence and charge the battery according to the normal charging sequence (S203) when the battery is normal. When a fault occurs in a charging system during charging or when discharge power is greater than charging power and thus a low-voltage fault is sensed (S204), the BMS may finish charging in order to prevent additional discharge and perform low-voltage fault reaction (that is, relay off) (S205). In contrast, when the low-voltage fault does not occur, charging may be maintained (S233).

If a battery fault is sensed before charging in step S204, whether a fault type is a low-voltage fault may be determined (S211). When the fault type is not a low-voltage fault, the BMS may perform fault reaction corresponding to the type (S212). When the fault type is a low-voltage fault, the BMS may prohibit low-voltage fault reaction from being performed (S211) and enter the normal charging sequence (S222). Here, prohibiting the low-voltage fault reaction from being performed may mean that the BMS performs low-voltage fault reaction for turning the relay off upon the low-voltage fault in a state in which the charging connector is not connected and overrides a logic for performing fault reaction and enters the charging sequence in a state in which the charging connector is connected.

After charging starts, the BMS may monitor charging current (S223), and finish charging and perform low-voltage fault reaction (that is, relay off) (S225) when a predetermined time has elapsed in a state in which charging current flows (S224), in order to prevent additional discharge of the battery in a state in which the battery is not substantially charged.

In a state in which charging current flows for a predetermined time or more (S231), the BMS may determine whether the voltage of the battery increases (S232). When the voltage of the battery increases, charging may be maintained (S233). If the voltage of the battery does not increase, charging may be finished and low-voltage fault reaction (that is, relay off) may be performed (S241).

A method of providing two relays in order to block the power path may be considered. For example, a charging power path for receiving charging power and a discharge power path for supplying power to a load may be physically branched and relays controlled by the BMS may be respectively provided on the paths, such that, when the charging connector is connected, only the relay provided on the discharge power path is turned off to perform the charging sequence.

The present disclosure may be implemented as code that can be written to, or implemented by, a computer-readable recording medium and can thus be read by a processor. The computer-readable recording medium may be any type of recording device in which data can be stored in a computer-readable manner. Examples of the computer-readable recording medium include a hard disk drive (HDD), a solid state drive (SSD), a silicon disk drive (SDD), ROM, a RAM, a CD-ROM, a magnetic tape, a floppy disk, an optical data storage, and a carrier wave (e.g., data transmission over the Internet).

Accordingly, the above detailed description is not to be construed as limiting the present disclosure in all aspects and should instead be considered as being merely exemplary. The scope of the present disclosure should be determined by reasonable interpretation of the accompanying claims and all equivalent modifications made without departing from the present disclosure should be included in the following claims.

What is claimed is:

1. A charging control method of a vehicle including an electric motor for supplying power for driving wheels and a battery for driving the electric motor, the charging control method comprising:
a battery management system (BMS) for determining whether the battery is normal or not;
activating a power blocking unit provided on a power output path of the battery upon determining that the battery is in an over discharge state;
deactivating the power blocking unit upon sensing that a charging connector of an external charger is connected; and
starting charging of the battery with charging power supplied through the charging connector while the power blocking unit is deactivated.

2. The charging control method according to claim 1, wherein a power output of the battery includes a charging power input and a discharge power output.

3. The charging control method according to claim 1, further comprising:
monitoring charging power after starting charging; and
activating the power blocking unit when a charging current is equal to or less than a threshold.

4. The charging control method according to claim 3, further comprising:
monitoring a voltage of the battery when the charging current exceeds the threshold for a predetermined time or more; and
activating the power blocking unit when the voltage of the battery does not increase.

5. The charging control method according to claim 1, wherein the deactivating of the power blocking unit is performed regardless of the over discharge state determination upon sensing that the charging connector is connected.

6. The charging control method according to claim 1, wherein:
the power blocking unit includes a relay, and
the vehicle includes an electric vehicle (EV), a plug-in hybrid electric vehicle (PHEV) and a fuel cell electric vehicle (FCEV).

7. A non-transitory recording medium having instructions which cause a controller to execute the steps of the method of claim 1.

8. A vehicle comprising:
an electric motor for supplying power for driving wheels;
a battery for supplying power to the electric motor;
a power blocking unit provided on a power output path of the battery; and
a battery management system (BMS) for sensing a state of the battery and controlling the power blocking unit,
wherein the battery management system activates the power blocking unit provided on the power output path of the battery upon determining that the battery is in an over discharge state, deactivates the power blocking unit upon sensing that a charging connector of an external charger is connected, and starts charging the battery with charging power supplied through the charging connector when the power blocking unit is deactivated.

9. The vehicle according to claim 8, wherein a power output of the battery includes a charging power input and a discharge power output.

10. The vehicle according to claim 8, wherein the battery management system monitors charging power after starting charging and activates the power blocking unit when a charging current is equal to or less than a threshold.

11. The vehicle according to claim 10, wherein the battery management system monitors a voltage of the battery when the charging current exceeds the threshold for a predetermined time or more and activates the power blocking unit when the voltage of the battery does not increase.

12. The vehicle according to claim 8, wherein the battery management system deactivates the power blocking unit regardless of the over discharge state upon sensing that the charging connector is connected.

13. The vehicle according to claim 8, wherein the power blocking unit includes a relay, and the vehicle includes an electric vehicle (EV), a plug-in hybrid electric vehicle (PHEV) and a fuel cell electric vehicle (FCEV).
